(19) United States
(12) Patent Application Publication
(10) Pub. No.: US 2005/0092947 A1
(43) Pub. Date: May 5, 2005

(54) Automatic valve assembly for dispensing carbon dioxide

(76) Inventor: Richard N. Fleming, Apollo Beach, FL (US)

Correspondence Address: QUARLES & BRADY LLP, 411 E. WISCONSIN AVENUE, SUITE 2040, MILWAUKEE, WI, 53202-4497, US

(21) Appl. No.: 10/963,225

(22) Filed: Oct. 12, 2004

Related U.S. Application Data
(60) Provisional application No. 60/515,986, filed on Oct. 31, 2003.

(51) Int. Cl. G01N 7/00; F16K 31/02

(52) U.S. Cl. 251/129.2

(57) ABSTRACT

A valve assembly for dispensing fluids prone to forming solids such as liquid carbon dioxide and liquid chocolate includes a valve which is held in a normally off position by a spring-activated plunger assembly. The spring-activated plunger assembly is coupled to a lifting arm, activated by a solenoid to counteract the spring and to selectively open the valve to allow fluid to flow. When the solenoid is deactivated the spring forces the valve closed, and the force of the spring forces any solid build up away from the valve aperture and valve seat.

### CROSS REFERENCE TO RELATED APPLICATION

This application claim the benefit of provisional patent application No. 60/515,986, filed Oct. 31, 2003, hereby incorporated by reference.

### STATEMENT REGARDING FEDERALLY SPONSORED RESEARCH OR DEVELOPMENT

Not applicable.

### BACKGROUND OF THE INVENTION

The present invention relates to control valves and more particularly to control valves for controlling a flow of fluids tending to form into solids when released.

Theme parks, theatrical groups, musical performers and others in the entertainment industry use “special effect” machines to enhance their presentations. Frequently, these special effects require the use of fluids or liquids which are selectively released or “shot” into the atmosphere to simulate various weather and environmental conditions, such as fog, which can be provided either as a bank, or in the form of “clouds”. When realistically simulated, fog bank and cloud effects can enhance scary, romantic, festive and dramatic performances by providing a dramatic backdrop to the performance.

One common method for producing fog effects is by releasing pressurized carbon dioxide into the atmosphere through a valve. The carbon dioxide can be released either in the vapor state, or in a liquid state. In the vapor state, the typical device for providing fog effects is a pneumatic hand-held carbon dioxide gun. These guns release vaporized carbon dioxide which can be, for example, found in the top of a tank of pressurized carbon dioxide. When the carbon dioxide vapor is released into the atmosphere, it intermixes with water in the atmosphere, which condenses into water droplets observable as fog.

Another method for producing fog, which is particularly useful for individual “cloud” effects, is by releasing liquid carbon dioxide into the atmosphere. Typically, the liquid carbon dioxide is withdrawn from the bottom of a tank, and released into the atmosphere through an automated, solenoid-driven valve. When released, the carbon dioxide removes water from the surrounding atmosphere, as described above, and condenses the water to provide a cloud effect. Devices for providing cloud effects typically employ solenoid-driven pilot-piston operated valves. The solenoid-driven valves open a small pilot orifice, creating a pressure imbalance across the piston, and allowing line pressure to lift the piston. The piston opens a main valve seat, which allows the carbon dioxide to flow. When the solenoid is de-energized, a plunger assembly drops onto the pilot seat, allowing pressure to build up above the piston, which closes the valve. In some applications, the plunger assembly is assisted by a piston spring, which helps to close the valve.

While devices for controlling fluid carbon dioxide therefore exist, the properties of carbon dioxide under pressure make controlling the flow of carbon dioxide difficult, in both the liquid and vapor states. Liquid carbon dioxide, for example, has a pressure to temperature ratio of about 78 psi. When the carbon dioxide pressure drops below 78 psi, as, for example, as it is released to the atmosphere, the carbon dioxide flashes quickly from liquid to vapor, and then to a dry ice solid. As the carbon dioxide passes through a valve, and into ambient temperatures, the carbon dioxide therefore can form into solid chunks. These chunks form on and in the output port valve, making it difficult to close the valve. Furthermore, the carbon dioxide can be very corrosive and, therefore, in addition to making the valve difficult to close, the carbon dioxide tends to erode the valve and valve orifice as it is used, significantly diminishing the life of the valve. The valves, therefore, typically have a limited life span, and can fail either due to ice or other solid build up in the valve or by corrosion of the valve orifice itself.

While these problems are pronounced while working with carbon dioxide special effects, similar problems exist with a number of other special effect liquids. Another common “special effect,” for example, is providing a flow of liquid chocolate which can be used to simulate lava or other effects. Here, the chocolate has a tendency to solidify as it enters ambient temperatures, and, like the carbon dioxide products, can form as a solid in and on the outlet valve. Valves employed for distributing chocolate, therefore, are also prone to failure due to solid build-up on the valve outlet port.

### BRIEF SUMMARY OF THE INVENTION

The present invention provides a valve for controlling a flow of special effect fluids to the atmosphere. The valve comprises a solenoid, a valve including an inlet port, an outlet port, and a mechanical plunger assembly selectively activated by the solenoid to provide an open position in which fluid flows from the inlet port to the outlet port, and a spring connected to the plunger assembly to force the valve to a closed position in which the plunger blocks the inlet port when the solenoid is deactivated. The spring is selected to have a spring constant which provides sufficient force to break solid build-ups from the output port when the valve is moved to the closed position.

In another aspect of the invention, a valve assembly is provided for automatically dispensing fluids prone to solidifying when released to the atmosphere. The valve assembly comprises an inlet port for receiving the fluid, an outlet port for dispensing the fluid, and a mechanical plunger assembly moveable between a first position in which the plunger closes the outlet and a second position in which the plunger opens the outlet. A spring is coupled to the mechanical plunger for forcing the mechanical plunger to a closed position, and the spring constant of the spring being selected to force the mechanical plunger over a solid build-up on the outlet port. A lifting assembly is coupled to the mechanical plunger for forcing the plunger to an open position, and to a solenoid wherein the solenoid is selectively activated to force the mechanical plunger to the open position, and deactivated to allow the plunger to close.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a cutaway perspective view of a valve assembly constructed in accordance with the present invention with the valve in the closed position;

FIG. 2 is a cutaway top perspective view of the valve assembly of FIG. 1;

FIG. 3 is a cutaway perspective view of the valve assembly of FIG. 1 with the valve in the closed position;

FIG. 4 is an exploded view of the valve assembly of FIG. 1 as coupled to the solenoid assembly of FIG. 1, as connected by the mounting bracket;

FIG. 5 is an exploded of the valve of FIG. 1 mounted to the mounting bracket.

### DETAILED DESCRIPTION OF THE INVENTION

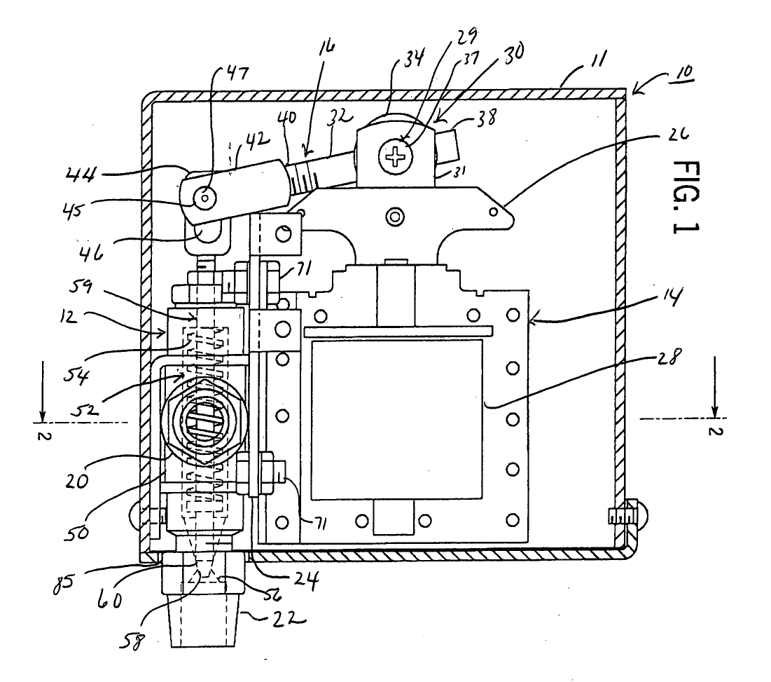

Referring now to the figures and more particularly to FIG. 1, a side view of a valve assembly 10 constructed in accordance with the present invention is shown. The valve assembly 10 comprises a solenoid assembly 14 coupled through a lifting assembly 16 to a valve 12. In operation the solenoid assembly 14 is activated by applied voltage to cause the lifting assembly 16 to force the valve 12 to an open position from which fluid can be dispensed through the valve 12 as described below. A spring 54 in the valve 12 maintains the valve 12 in a normally closed position, and provide sufficient force to drive out blockages that form in the output of the valve 12, as described below. The valve 12, solenoid assembly 14, and lifting assembly 16 are further coupled together on a mounting bracket assembly 24 to provide a compact assembly suitable for mounting inside of a housing 11, also as described below.

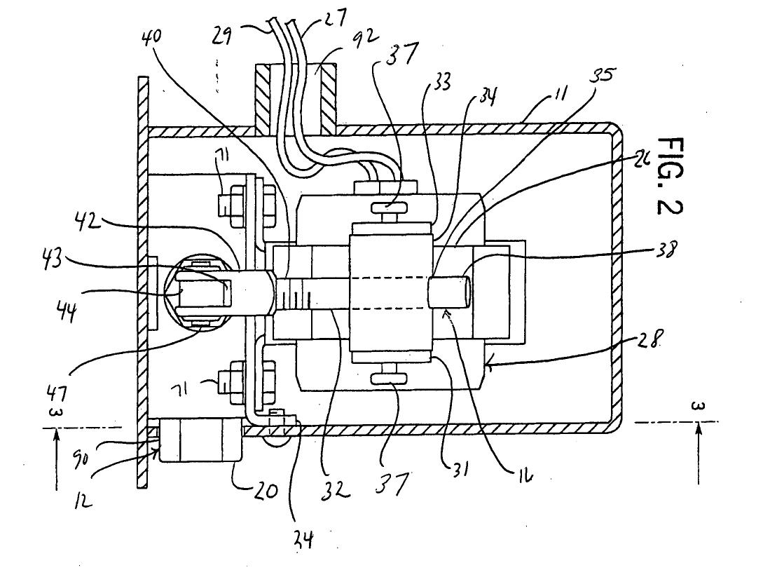

Referring still to FIG. 1 and also to FIG. 2, the solenoid assembly 13 comprises a solenoid 28, a solenoid-activated plunger 26, and a bracket 30 for receiving one end of the lifting arm assembly 16. The bracket 30 extends vertically upward from the top of the plunger 26, and includes first and second vertically extending parallel mounting plates 31 and 33, which are coupled together with a cylindrical mounting device 34 including an aperture 35 sized and dimensioned to receive a portion of the lifting assembly 16. Each of the mounting plates 31 and 32 includes an aperture 29 for receiving a fastener 37 to rotationally couple the cylindrical mounting device 34 to the adjacent plates 31 and 33. The solenoid 28 is further connected to two electrical control lines 27 and 29, which are routed through an aperture in the housing 11 and are connectable to an external electrical triggering device. Although a number of solenoid assemblies could be used, a solenoid and plunger assembly useful in the present invention is commercially available from Dormeyer Products of Vandalia, Ohio as Part No. 7612-S.

Referring still to FIG. 1 and also to FIG. 2, the lifting assembly 16 comprises an actuator arm 32 coupled to a valve assembly mounting bracket 42 at a first end 40 and to the cylindrical mounting member 34 of the solenoid assembly mounting bracket 30 at an opposing end 38. The valve assembly mounting bracket 42 extends radially away from and substantially parallel to the end 40 of the actuator arm 32, and includes an open-ended slot 43 for receiving a mating connector 44 from the valve 12. Apertures 45 are provided on the opposing sides of the slot 43 for receiving a fastener 47 for coupling the valve assembly mounting bracket 42 to the mating connector 44, as described below.

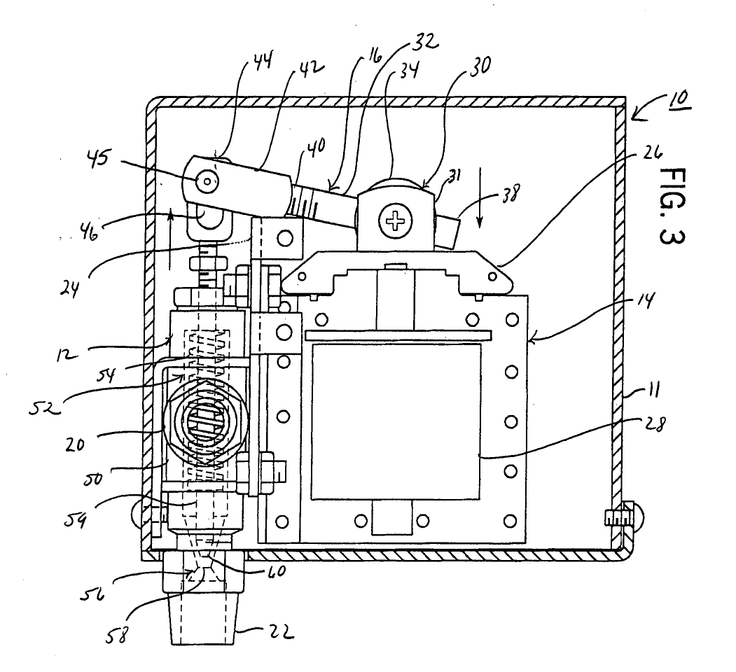

Referring now to FIGS. 1 and 3, the valve 12 comprises a sleeve 50, an inlet port 20, an outlet port 22, and a mechanical plunger assembly 52 for selectively providing fluid flow from the inlet port 20 to the outlet port 22. The sleeve 50 is substantially cylindrical, with the inlet port 22 formed in a side of the cylinder, the outlet port 22 formed at one end, and an aperture (not shown) at the opposing end. The inlet port 20 can be threaded or provided with a fitting to be connectable to a source of fluid carbon dioxide or other fluids The outlet port 22 includes a valve seat 56 with an aperture 58 sized and dimensioned to be selectively opened or closed by the mechanical plunger assembly 52. The outlet port 22 and valve seat 56 can be constructed of stainless steel, Kevlar® or other non-corrosive materials, or coated with an anti-corrosive coating such as Teflon® to limit corrosion caused by the fluid or liquid carbon dioxide, as described below.

Referring still to FIGS. 1 and 3, the mechanical plunger assembly 52 extends through the sleeve 50 from the aperture at the top of the cylinder to the outlet port 22, and comprises a pin 59 terminating at one end in a valve plug 60 sized and dimensioned to selectively block the aperture 58, and at the opposing end in the connector 44. A spring 54 is coupled around the pin 59 and acts on the pin 59 and associated valve plug 60 to force the valve plug 60 into the aperture 58 in the valve seat 56, thereby retaining the valve 12 in a closed position when inactive. The spring constant of the spring 54 is therefore selected to provide sufficient force to drive the valve plug 60 through ice and other solid build-ups in the outlet port 22, unblocking the aperture 58 to assure repeatability.

The mating connector 44, at the opposing end of the pin 59, comprises a substantially rectangular bracket 42 with a slot 46 formed substantially in the center. The connector 44 is received in the slot 43 in the bracket 42 of the lifting arm assembly 16, and the fastener 47 is extended through the apertures 45, through the slot 43 in the center of the bracket 42, and through the slot 46 in the connector 44 to rotationally couple the mating connector 44 to the bracket 42, thereby connecting the valve 12 to the lifting assembly 16.

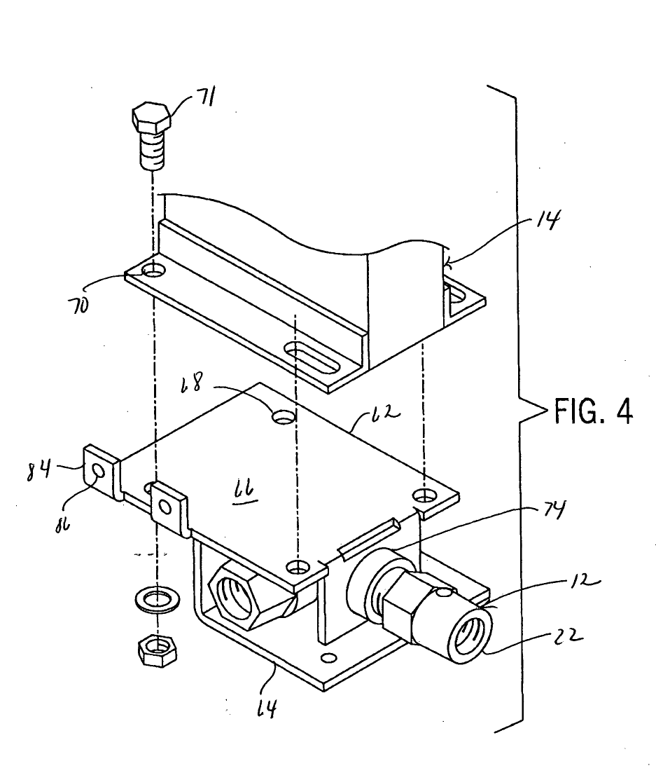

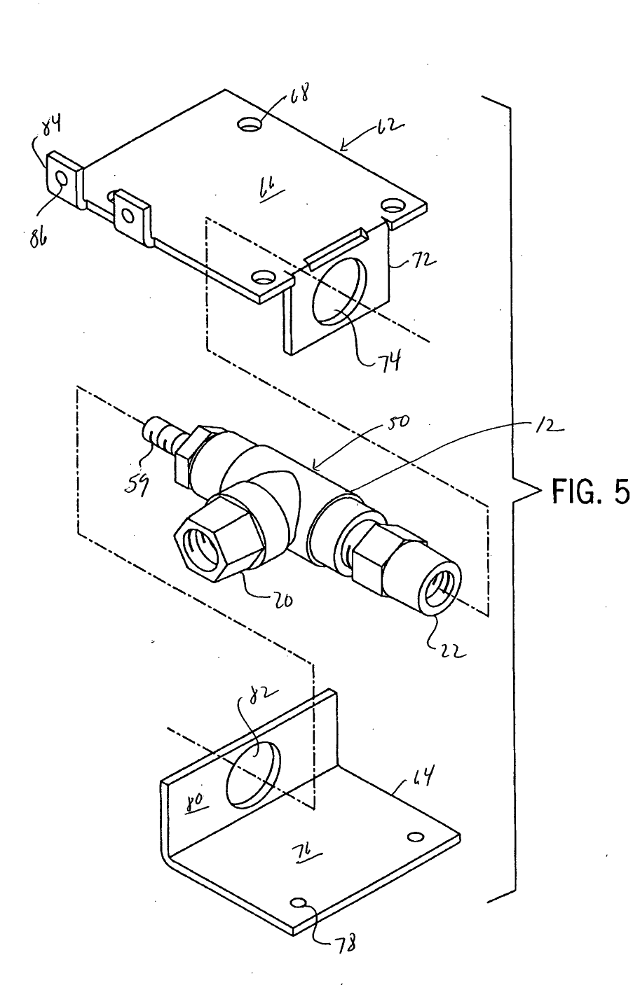

Referring now to FIGS. 4 and 5, the valve 12 is received in the mounting bracket assembly 24 for mounting the valve 12 to both the solenoid assembly 14 and the housing 11. The mounting bracket assembly 24 includes a solenoid mounting plate 62 for mounting the valve 12 to the solenoid assembly 14, and a valve mounting plate 64 for mounting the valve 12 to the housing 11. The solenoid mounting plate 62 includes a generally flat plate section 66 including four apertures 68 for receiving fasteners 71 to mount the plate 66 to holes 70 in the solenoid assembly 14, and an outlet valve mounting plate 72, extending substantially perpendicular to the flat plate section 66 and including an aperture 74 sized and dimensioned to receive the outlet port 20 of the valve 12. One or more tabs 84 extend perpendicularly from a side of the flat plate section 66, and include apertures 86 to receive fasteners for coupling the solenoid mounting plate 62 to the housing 11.

The valve mounting bracket 64 also includes a generally flat plate section 76 including two apertures 78 for mounting the assembly to the housing 11, and a mechanical plunger assembly mounting plate 80, extending substantially perpendicular to the generally flat plate section 76 and including an aperture 82 sized and dimensioned to receive the housing 50 and mechanical plunger assembly 52.

Referring again to FIGS. 1-3, the valve assembly 12 and solenoid assembly 14 are shown as mounted to the mounting bracket assembly 24 in the housing 11. Referring first to FIG. 1, an aperture 85 is provided in the housing for receiving the outlet port 20 of the valve 12. Referring now to FIG. 2, the housing further comprises an aperture 90 for receiving the inlet port 22 and an aperture 92 for routing control wires 27 and 29 to the solenoid 28 outside of the housing 11 for connection to external activating devices.

Referring again to FIG. 1, in operation, a source of fluid, preferably, liquid carbon dioxide is connected to the inlet port 20 through a fitting. The valve 12 defaults to an off position in which the solenoid 28 is inactive, and the spring 54 in the mechanical plunger assembly 52 retains the valve plug 60 in the valve seat aperture 58 preventing release of the source fluid. When a voltage is applied across the solenoid 28, the solenoid plunger 26 is driven vertically downward as shown in FIG. 3. As the solenoid plunger 26 moves downward, the end 38 of the actuator arm 32 of the lifting assembly 16 is rotated downward toward the solenoid 28, and the mechanical plunger assembly 52 is pulled upward by bracket 42 of the opposing end 40 of the actuator arm 32, lifting the valve plug 60 from the aperture 58 in the valve seat, and allowing fluids to flow from the inlet port 20 to the outlet port 22. As noted above, while dispensing carbon dioxide or other fluids prone to form solids, solids can build up on the valve seat 56 and outlet port 22, clogging the valve aperture 58 and making it difficult or impossible to dispense fluids.

Referring again to FIG. 1, when the solenoid 28 is again deactivated, the spring 54 in the mechanical plunger assembly 52 forces the plug 60 downward, forcing the valve plug 60 onto the valve aperture 58 in the valve seat 56, and closing the valve 12, stopping the flow of fluid from the inlet 20 to the outlet port 22. Furthermore, the spring force causes the valve plug 60 to force blockages from the valve aperture 58 and valve seat 56, thereby minimizing or preventing problems with fluid blockages. As described above, to further improve repeatability of activation and to limit damage to the valve 12, the valve seat 56, the outlet port 22, inlet port 20, and/or the entire valve 12 can be constructed of corrosion-resistant materials such as stainless steel or Kevlar®, or coated with anti-corrosive coatings such as Teflon®.

Although a specific embodiment of the present invention has been shown and described, it will be apparent that a number of modifications could be made within the scope of the invention. For example, although a specific solenoid-driven lifting assembly has been shown, it will be apparent that mechanical assemblies could be provided in a number of different configurations, and employing a number of different parts. Similarly, variation in the bracketing, configuration of the valve, and solenoid assembly are within the scope of the invention.

It should be understood therefore that the methods and apparatuses described above are only exemplary and do not limit the scope of the invention, and that various modifications could be made by those skilled in the art that would fall under the scope of the invention. To apprise the public of the scope of this invention, the following claims are made:

1. A valve for controlling a flow of special effect fluids to the atmosphere, the valve comprising:
a solenoid;
a valve including an inlet port, an outlet port, and a mechanical plunger assembly selectively activated by the solenoid to provide an open position in which fluid flows from the inlet port to the outlet port; and
a spring connected to the plunger assembly to force the valve to a closed position in which the plunger blocks the inlet port when the solenoid is deactivated, the spring having a spring constant selected to provide sufficient force to break solid build-ups from the output port when moved to the closed position.

2. The valve as defined in claim 1, wherein the mechanical plunger assembly comprises:
a solenoid-activated plunger;
an actuator arm pivotally coupled to the plunger at a first end; and
a valve plunger provided between the inlet and the outlet port and coupled to a second end of the actuator arm, wherein when the solenoid is activated the solenoid-activated plunger is driven vertically upward causing the actuator arm to pivot downward at the first end, and driving the valve plunger upward at the second end.

3. The valve as defined in claim 1, wherein valve outlet comprises a corrosion resistant material.

4. The valve as defined in claim 1, wherein the valve outlet is coated with a Teflon or a, Kevlar.

5. The valve as defined in claim 1, wherein the valve outlet is constructed of a stainless steel.

6. The valve as defined in claim 1, wherein the fluid is a material prone to forming solids upon release to the atmosphere.

7. The valve as defined in claim 1, wherein the fluid is carbon dioxide.

8. The valve as defined in claim 1, wherein the fluid is a liquid carbon dioxide.

9. The valve as defined in claim 1, wherein the fluid is a liquid nitrogen.

10. The valve as defined in claim 1, wherein the fluid is a liquid chocolate.

11. A special effects valve for automatically dispensing fluids, the device comprising:
an inlet valve coupled to the first aperture in the housing;
an outlet valve coupled to the second aperture in the housing;
a mechanical plunger coupled between the inlet and the outlet valves and selectively moveable between an open and a closed position to provide a flow of fluid from the inlet to the outlet valve;
a solenoid-activated plunger coupled to the mechanical plunger, wherein when the solenoid is activated, the solenoid-activated plunger causes the mechanical plunger to move from the closed to the open position; and
a spring coupled to the mechanical plunger to force the mechanical plunger to the closed position, wherein when the solenoid is deactivated, the spring forces the mechanical plunger to a closed position.

12. The special effects valve as defined in claim 11, wherein the fluid is prone to developing into a solid at the output port and the spring has a spring force selected to overcome the solid build-up on the outlet port.

13. The special effects valve as defined in claim 11, wherein the solenoid activated plunger is coupled to the mechanical plunger through an actuator arm, the actuator arm being pivotally coupled to the solenoid-activated plunger at a first end and to the mechanical plunger at the second end.

14. The special effects valve as defined in claim 13, wherein the solenoid activated plunger is forced vertically downward when the solenoid is activated, causing the actuator arm to pivot upward, pulling the mechanical valve assembly up to open position.

15. The special effects valve as defined in claim 11, wherein at least one of the inlet port and the outlet port are constructed of an anti-corrosive material.

16. A valve assembly for automatically dispensing fluids prone to solidifying when released to the atmosphere, the valve assembly comprising:
an inlet port for receiving the fluid;
an outlet port for dispensing the fluid;
a mechanical plunger assembly moveable between a first position in which the plunger closes the outlet and a second position in which the plunger opens the outlet;
a spring coupled to the mechanical plunger for forcing the mechanical plunger to a closed position, the spring constant of the spring being selected to force the mechanical plunger over a solid build-up on the outlet port;
a lifting assembly coupled to the mechanical plunger for forcing the plunger to an open position; and
a solenoid coupled to the lifting assembly, wherein the solenoid is selectively activated to force the mechanical plunger to the open position.

17. The valve assembly as defined in claim 16, wherein the lifting assembly comprises a solenoid driven plunger and an actuator arm, the actuator arm being coupled between the solenoid driven plunger and the mechanical plunger to raise the mechanical plunger when the solenoid is activated.

18. The valve assembly as defined in claim 17, wherein the actuator arm is pivotally coupled at one end to the solenoid-driven plunger and at the opposing end to the mechanical plunger.

19. The valve assembly as defined in claim 16, further comprising a housing including a first aperture for receiving the inlet port and a second aperture for receiving the outlet port.
